(19) United States
(12) Patent Application Publication
(10) Pub. No.: US 2022/0261094 A1
(43) Pub. Date: Aug. 18, 2022

(54) DEVICE TILT ANGLE AND DYNAMIC BUTTON FUNCTION

(71) Applicant: Elo Touch Solutions, Inc., Milpitas, CA (US)

(72) Inventors: Cameron Charles COLE, Milpitas, CA (US); Ranil Ignatius Fernando, Sunnyvale, CA (US); Fareed Uddin, San Jose, CA (US); Seda Kutlu, Redwood City, CA (US); Kenneth John North, San Carlos, CA (US); Joel Christopher Kent, Fremont, CA (US)

(21) Appl. No.: 17/177,847

(22) Filed: Feb. 17, 2021

(51) Int. Cl. G06F 3/0346; G06F 3/02; G06F 3/16; H04M 1/72466; G06K 7/14

(52) U.S. Cl. CPC G06F 3/0346; G06F 3/0202; G06K 7/1413; H04M 1/72466; G06F 3/165

(57) ABSTRACT

Some embodiments include a handheld device with programmable physical buttons. The physical buttons may be configured to perform different actions based on an orientation of the handheld device. Dynamically mapping actions to physical buttons may be based on an orientation condition that measures any one of orientation state of the device, a current application state, a change in the orientation state, or current device status. The actions may be updated automatically based on the orientation condition.

### BACKGROUND

### Field

The present disclosure relates generally to a touchscreen device, and in particular, a touchscreen device with dynamic button functions based on tilt angle.

### Background Art

Handheld devices may include a number of physical buttons which may be located on both left and right-hand sides of the devices. When a user launches an application, such as by touching an icon, the function associated with a physical button may change based on the launched application. However, within a given application or “app”, and when the user has not touched an icon to load a new app, functions assigned to these physical buttons are typically static and do not change based on different contexts for which the devices may be used or even different orientations of the device.

### SUMMARY

Some embodiments include a system, method, computer program product, and/or combination(s) or sub-combination(s) thereof, for a handheld device with programmable physical buttons in addition to providing a touchscreen display. Some embodiments include a handheld device with physical buttons outside of the touchscreen and may be located on left and right sides of the wireless handheld device. Some embodiments include a controller coupled to the handheld device, configured to dynamically configure functions performed by the physical buttons based on different or changing contexts of the handheld device. Non-limiting examples of contexts include orientation states and application states which may represent a current state of the handheld device or a transition from one state to different state.

Further embodiments, features, and advantages of the present disclosure, as well as the structure and operation of the various embodiments of the present disclosure, are described in detail below with reference to the accompanying drawings.

### BRIEF DESCRIPTION OF THE DRAWINGS/FIGURES

The accompanying drawings, which are incorporated herein and form part of the specification, illustrate the present disclosure and, together with the description, further serve to explain the principles of the disclosure and to enable a person skilled in the relevant art(s) to make and use the disclosure.

FIG. 1 illustrates an overview of an example implementation, according to an exemplary embodiment of the disclosure;

FIG. 2 illustrates an example wireless handheld device in which methods described herein may be implemented, according to an exemplary embodiment of the disclosure;

FIGS. 3A and 3B illustrate example orientations of a handheld device, according to an exemplary embodiment of the disclosure;

FIGS. 4A and 4B illustrate an example use of a handheld device based on different orientation states, according to an exemplary embodiment of the disclosure;

FIGS. 5A and 5B illustrate example function maps mapping device orientation states to button functions, respectively, according to an exemplary embodiment of the disclosure;

FIGS. 5C and 5D illustrate example orientation maps mapping device orientation to device orientation states, respectively, according to an exemplary embodiment of the disclosure;

FIGS. 6A-E illustrate exemplary flowcharts for updating functions of buttons and/or device settings of a handheld device based on device orientation and/or an orientation state, according to exemplary embodiments of the disclosure;

FIG. 7 illustrates an example computer system useful for implementing and/or using various embodiments.

The present disclosure will now be described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

The following Detailed Description of the present disclosure refers to the accompanying drawings that illustrate exemplary embodiments consistent with this disclosure. The exemplary embodiments will fully reveal the general nature of the disclosure that others can, by applying knowledge of those skilled in relevant art(s), readily modify and/or adapt for various applications such exemplary embodiments, without undue experimentation, without departing from the spirit and scope of the disclosure. Therefore, such adaptations and modifications are intended to be within the meaning and plurality of equivalents of the exemplary embodiments based upon the teaching and guidance presented herein. It is to be understood that the phraseology or terminology herein is for the purpose of description and not of limitation, such that the terminology or phraseology of the present specification is to be interpreted by those skilled in relevant art(s) in light of the teachings herein. Therefore, the detailed description is not meant to limit the present disclosure.

The embodiment(s) described, and references in the specification to “one embodiment”, “an embodiment”, “an example embodiment”, etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

A handheld device may include one or more physical buttons. The handheld device may be implemented as a wireless handheld device that is capable of wireless communications. Typically, one button may be configured as a power button for turning the wireless handheld device on or off. Other examples of physical buttons may include a button or buttons for controlling the volume of the device. These functions are typically static in nature regardless of how the device is currently oriented, or the device orientation. For example, a left physical button (i.e., a physical button located on a left side of the device) may be hardcoded to increase the volume of the device while a right physical button (i.e., a physical button located on an opposing right side of the device) may be hardcoded to decrease the volume of the device. In a conventional implementation of a wireless handheld device, these volume functions are static and do not change even if the device orientation (e.g., tilt angle) changes. In a conventional implementation, alternate functions of physical buttons of the wireless handheld device may be activated based on whichever application is currently loaded and being executed (such as by the user loading the application with the touch of an icon). But such activations are typically static (i.e., the function of the button remains the same for the application) and also require an explicit user interaction with software on the wireless handheld device. In contrast, in some embodiments, changes to physical button function may be triggered by a change in hardware, such as a device orientation. In some embodiments, the trigger may be both a change in a combination of hardware and software.

In some embodiments, device orientation may be used for determining an orientation state of the wireless handheld device. Device orientation may refer to quantitative measurements that reflect the positioning of wireless handheld device in a three-dimensional space. Device orientation may refer to a continuous range of values (e.g., angles) representing positioning of the wireless handheld device. In some embodiments, this positioning may be based on a relationship to a reference vector, such as gravity. Wireless handheld device may include internal components for determining the quantitative measurements which may be implemented as, for example, angles calculated between the direction of gravity and an X, Y, and Z axis of the wireless handheld device.

Some embodiments include mapping the quantitative measurements, or device orientation, to orientation states. Orientation states may be a discrete set of predefined values that are associated with a certain range or set of values represented by the device orientation. Non-limiting examples of orientation states include vertical orientation, horizontal orientation, vertical orientation with a left tilt, and vertical orientation with a right tilt. Orientation states may further be mapped to different functions to be performed by programmable physical buttons of the wireless handheld device. A controller of the wireless handheld device may dynamically update the functions of the physical buttons responsive to determining the current orientation state of the wireless handheld device.

Some embodiments include using the quantitative measurements to determine transitions between different orientation states, such as from a horizontal position to a vertical position. Detecting the extent of transitions, such as changes in angles along the X, Y, or Z axes, allows a controller of the wireless handheld device to prevent functions of the programmable physical buttons from being changed due to small shifts in orientation. Detecting transitions angles allows the controller to provide a buffer or range when to stay within an orientation state or when to transition to a different orientation state.

Embodiments described herein may allow for updating functions of programmable physical buttons. A benefit of this approach is to allow for fewer buttons to be implemented on the wireless handheld device since functions of a button may be updated dynamically as needed based on the orientation of the device. Fewer buttons implemented on the sides of the device reduces cost of the device and simplifies antenna design because there is less mechanical interference for an antenna signal.

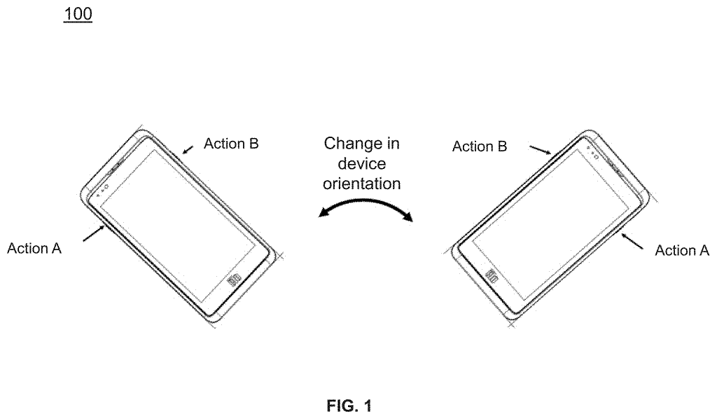

Each user may want to adjust the device speaker volume per their personal preferences. It may be desirable for the adjustment mechanism is intuitive whether the user listens with their right ear or left ear, e.g. by mapping left and right programmable buttons to volume up and volume down as discussed in connection with FIGS. 1-5A above. Accordingly, a handheld device of the present disclosure does not need to implement wireless communications in order to support orientation state dependent button function assignments.

FIG. 1 is a diagram of an overview of an example implementation 100 described herein. As shown in FIG. 1, example implementation 100 may include a wireless handheld device, such as a smart phone. The device may include a touchscreen display and physical buttons located on opposing sides of the device.

As shown in FIG. 1, the wireless handheld device may detect a change in an orientation state or a new orientation state and adjust a function of at least one programmable physical button. For example, the wireless handheld device may detect a change in an orientation state from a first tilt position to a second tilt position; alternatively, or additionally, the wireless handheld device may detect a current orientation state as being in the second tilt position without any relation to the prior orientation state. The wireless handheld device may use an orientation sensor to detect a device orientation such a position in three-dimensional space as determined in relation to a reference vector that may also be detected by the orientation sensor. In some embodiments, an orientation sensor may include any combination of an accelerometer, a gyroscope, and a compass. Based on detecting a change in orientation state or a new orientation state, a controller of the wireless handheld device may configure functions of physical buttons. The physical buttons may be located on opposing sides of the wireless handheld device; there may be more than one physical button implemented as part of the wireless handheld device.

An example of configuring functions of physical buttons is shown in example implementation 100. In one orientation state with a first tilt, a button located on a left-hand side of the wireless handheld device may be configured to perform action A when the button is pressed while a button located on an opposing right-hand side may be configured to perform action B when the button is pressed. Conversely, when in a second orientation state, the left-hand side button may be reconfigured to perform action B when pressed and the right-hand side button may be reconfigured to perform action A when pressed. Actions A and B may control software functions associated with applications installed on the wireless handheld device. The reconfiguration is triggered by a change of hardware, such as a device orientation, and requires no explicit interaction with software such as by touching an icon.

In one embodiment, the software function may be a volume control and actions may be to increase or decrease the volume. Actions may be mapped to buttons based on the application. For example, during a phone call, it may be intuited that the wireless handheld device is pressed against a left ear when the device is in a vertical orientation but tilted to the left. Actions of the left and right buttons may be assigned intuitively to match the user's expectations such as assigning volume down action to the left button (because it is facing downward) and the volume up action to the right button (because it is facing upward). Similarly, it may be intuited that the wireless handheld deivce is pressed against a right ear when the device is in a vertical orientation but tilted to the right. Actions performed by the buttons may be reconfigured accordingly. With a tilt to the right, the volume up action may now be assigned to the left button (because it is facing upward) and the volumen down action to the right side button (because it is facing downward). In this manner, depending on the tilt, actions performed by the side button may vary so that button actions remain intuitive regardless of whether the user holds the handheld device to the left ear or the right ear.

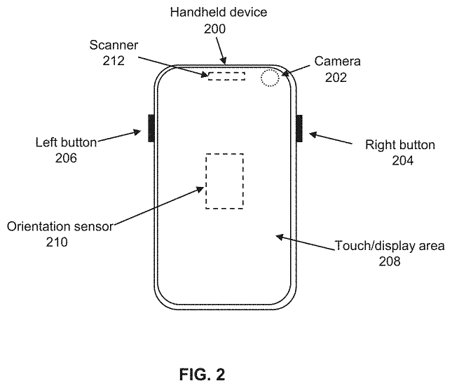

FIG. 2 is a diagram of an example wireless handheld device 200. As shown in FIG. 2, wireless handheld device may include a camera 202, a right programmable button 204, a left programmable button 206, a touch/display area 208, an orientation sensor 210, and a scanner 212. The touch/display area 208 comprises a thin and transparent touchscreen placed over a display such as an LCD. While FIG. 2 discusses wireless handheld device 200, it should be understood that in other embodiments, wireless handheld device 200 may be implemented as a handheld device without any wireless communication (i.e., lacking hardware components) or with its wireless capability disabled.

Wireless handheld device 200 may be implemented as any device that uses physical buttons to control actions of software installed on or hardware of wireless handheld device 200. Non-limiting examples of installed software may include a camera application, a media application (for playing music, video, or other media), and a phone application. Non-limiting examples of actions of software may include any functionality associated with applications installed on wireless handheld device 200 such as volume control for a media application or a phone application, a media control for a media application, and a shutter control for a camera application. For example, wireless handheld device 200 may be implemented as a mobile phone (e.g., a smart phone), a computing device (e.g., a tablet), or a similar device.

In some embodiments, camera 202 may be implemented as a rear-facing camera and a forward-facing camera. In some embodiments, camera 202 refers to either a rear-facing camera or a forward-facing camera. Camera 202 may be associated with a software installed on wireless handheld device 200 that is controlled via at least one of a right programmable button 204 or left programmable button 206. For example, right programmable button 204 may be configured to operate a shutter of camera 202 and left programmable button 206 may be configured to operate other options (e.g., flash setting, camera modes) of camera 202.

While only two buttons are illustrated in FIG. 2, wireless handheld device 200 may be implemented with any number of programmable buttons. In an embodiment, to reduce costs and streamline antenna design, the number of programmable buttons is minimized; in such an embodiment, wireless handheld device 200 may be implemented with two programmable buttons as indicated in FIG. 2. In some embodiments, when implemented with two or more buttons, at least two buttons are located on opposing sides of wireless handheld device 200. For example, in the embodiment shown in FIG. 2, right programmable button 204 is located on a right side of wireless handheld device 200 and left programmable button 206 is located on a left side of wireless handheld device 200.

In some embodiments, wireless handheld device 200 may include touch/display area 208 for displaying applications and receiving input from a user for launching and changing applications. Wireless handheld device 200 may include orientation sensor 210. Orientation sensor 210 may measure device orientation of the wireless handheld device with respect to a reference vector and coordinate axes, X, Y, and Z in relation to the device.

Wireless handheld device 200 may further include scanner 212. In some embodiments, scanner 212 may be a barcode scanner that emits a beam such as a laser for reading barcodes. Scanner 212 may be associated with a scanner application that is controlled via at least one of right programmable button 204 and left programmable button 206. For example, right programmable button 204 may be configured to activate the beam of scanner 212 and left programmable button 206 may be configured to operate other options of camera 202. In another embodiment, both right and left programmable buttons 204 and 206 may be configured to activate the beam of scanner 212.

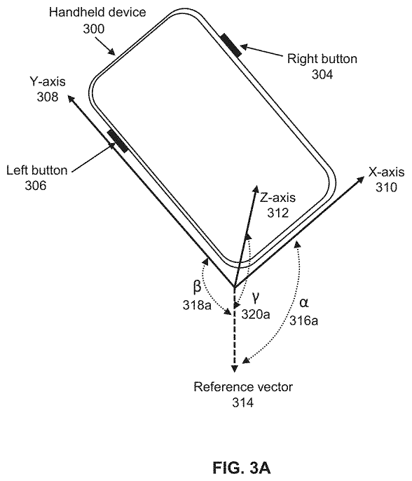

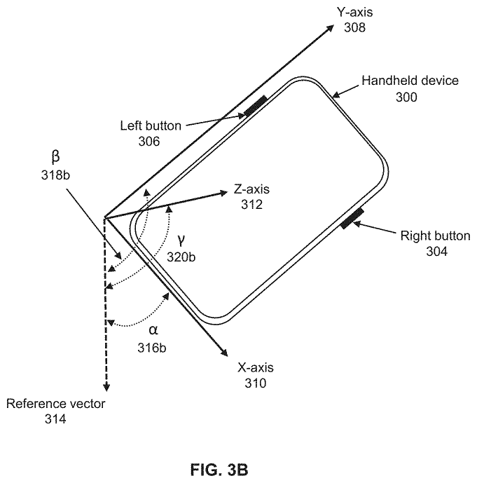

FIGS. 3A and 3B illustrate example orientations of wireless handheld device 300, according to an exemplary embodiment. Wireless handheld device 300 may correspond to wireless handheld device 200. In an embodiment, a device orientation may refer to the physical orientation of the handheld device with respect to a reference vector such as gravity. Device orientation may be quantitatively specified by the angles between the downward pull of gravity and X, Y and Z axes associated with the handheld device. While FIGS. 3A-3B discusses wireless handheld device 300, it should be understood that in other embodiments, wireless handheld device 300 may be implemented as a handheld device without any wireless communication (i.e., lacking hardware components) or with its wireless capability disabled.

FIG. 3A illustrates an example orientation state where wireless handheld device 300 is in a vertical position with a left tilt with respect to Y-axis 308, X-axis 310, Z-axis 312, and reference vector 314 (e.g., gravity). Y-axis 310 may be parallel to the long dimension of wireless handheld device 300 and Z-axis 312 may be perpendicular to the touchscreen surface of wireless handheld device 300. X-axis 310 may be perpendicular to Y-axis 308 and Z-axis 312.

Device orientation of wireless handheld device 300 may be defined with respect to reference vector 314, and may be quantitatively specified based on angles α 316a, β 318a, and γ 320a between reference vector 314 and the X-axis 310, Y-axis 308, and Z-axis 312, respectively. The device orientation of wireless handheld device 300 may also be specified with the cosines of these angles, or cos(α), cos(β), and cos(γ) which may be interpreted as components of a vector of unit length. As a non-limiting example, if the variable “G” represents the unit vector in the direction of reference vector 314, then, with respect to the device's coordinate system, its X, Y and Z components may be given by the following expression:

G=(Gx, GY, Gz)=(cos(α), cos(β), cos(γ))

Angles α 316a, β 318a, and γ 320a may represent a device orientation and may be used to define device orientation states. As non-limiting examples, when γ 320a=180° and G=(0, 0, −1), the device orientation state may be described as being in a face-up (user facing) horizontal orientation and when β 318a=180° and G=(0, −1, 0), the device orientation state may be described as being in a vertical position. An additional non-limiting example may include when γ 320a=90° and α 316a is greater than 90°, G=(G_{X}<0, G_{Y}, 0), the device orientation state may be described as being vertical with a left tilt which may correspond to wireless handheld device 300 being held by a user with the left hand next to the left ear such as during a phone conversation. An additional non-limiting example may include when γ 320a=90° and α 316a<90°, G=(G_{X}>0, G_{Y}, 0), the device orientation state may be described as being vertical with a right tilt which may correspond to wireless handheld device 300 being held by a user with the right hand next to the right ear during a phone conversation. These descriptions of orientation states are merely exemplary and are not intended to limit the scope of how orientation states may be associated with the measured device orientations. In addition to the orientation of wireless handheld device 300, the orientation state may be impacted by other factors such as the purpose of the software currently running, the history of past orientations, and orientation states.

With reference to FIG. 3A, wireless handheld device 300 may be described as being in a vertical position with a left tilt in accordance with the description above with respect to γ 320a=90° and α 316a<90°. Wireless handheld device 300 in this particular device orientation state may have a first set of actions mapped to right button 304 and left button 306, respectively. Wireless handheld device 300 may be displaying a software application; the displayed software application may be considered to be “active.” The software application may support one or more “application modes” of programmable touch button usage. For example, one or more sets of actions may be associated with a first application mode. In this first application mode, the software application may support the one or more sets of actions via programming the programmable button functions. For example, the first application mode may indicate that the software application has phone capability (a phone mode) in which the programmable buttons support actions related to increasing or decreasing the volume of wireless handheld device 300 when the software application is in a phone mode (such as when the software application is providing phone call capability). The phone mode of the software application may have any number of sets of actions that may be mapped depending on the device orientation. For example, when wireless handheld device is in a first device orientation, a first set of actions for the physical buttons may be specified and when in a second device orientation, a second set of actions may be specified.

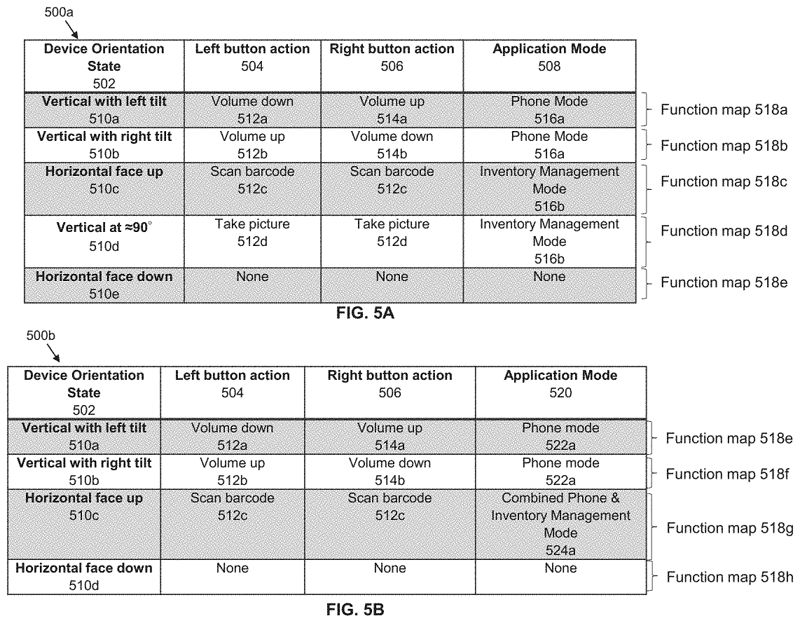

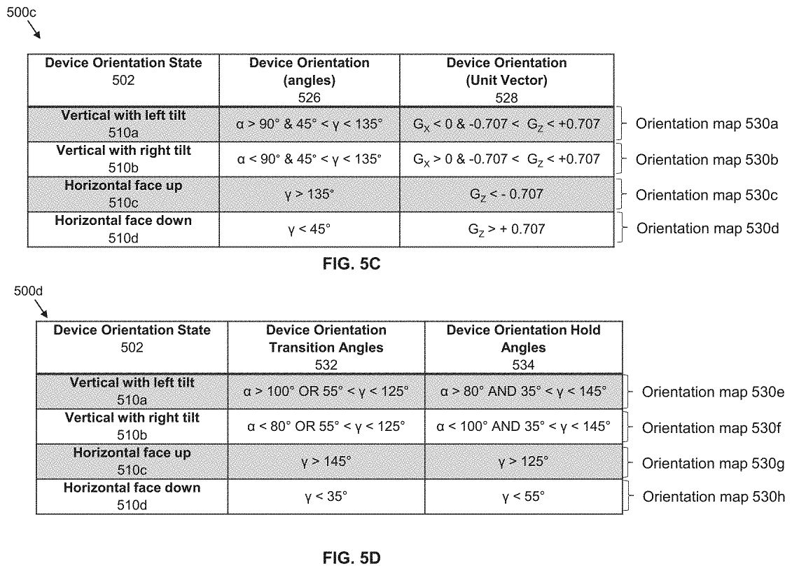

A second application mode may refer to another capability of the software application such as a camera capability (camera mode), email capability (email mode), inventory management capability (inventory management mode), music capability (music mode). In this embodiment, the software application is described as having two different modes. But in other embodiments, the software application may have any number of modes including one (i.e., only a single mode such as a phone mode) or three or more as just described. Each of these modes may be mapped to different sets of actions. For example, in a music mode, actions may control functions for changing songs, in a camera mode, actions may control taking pictures. These may be called “function maps” and are discussed further with respect to FIGS. 5A-5D.

With reference to FIG. 3B, device orientation of wireless handheld device 300 may be defined with respect to reference vector 314, and may be quantitatively specified based on angles α 316b, β 318b, and γ 320b between reference vector 314 and the X-axis 310, Y-axis 308, and Z-axis 312, respectively. In an embodiment, wireless handheld device 300 may be described as being in a vertical position with a right tilt state in accordance with the description above with respect to γ 320b=90° and α 316b<90°. Wireless handheld device 300 in this particular device orientation state may have a second set of actions mapped to right button 304 and left button 306, respectively. The second set of actions may be different or overlap with the first set of actions. A controller of wireless handheld device 300 may dynamically switch from the first set of actions to the second set of actions upon detecting an orientation condition, such as transitioning from the vertical with left tilt orientation state to the vertical with right tilt orientation state or merely upon detecting that wireless handheld device 300 is in the vertical with right tilt orientation state. In an embodiment, the phone mode may be associated with a particular software application and may support both the first and second set of actions depending on the device orientation.

Device orientation states may further be associated with the different application modes. For example, a horizontal orientation state my trigger a different application mode such as the chat mode, inventory management mode, or email mode. When the controller of wireless handheld device 300 detects a transition from the horizontal orientation state to a vertical orientation state, the controller may cause the application software to return to the first application mode (e.g., phone mode) in which first and second set of actions that may be mapped to right button 304 and left button 306 in a way depending on device orientation. For example, in the embodiment shown in FIGS. 3A and 3B, the software application running on the wireless handheld device may return to the first application mode. In an embodiment, the device orientation may determine which of the modes has priority. The switching of application modes does not require user interaction with the software application or any other software (e.g., the operating system) or interaction with touch/display area 208.

As a non-limiting example, when wireless handheld device 300 is in a vertical position with left tilt orientation state (such as shown in FIG. 3A) and when the application mode of wireless handheld device 300 indicates that the phone application mode is currently active, a controller of wireless handheld device 300 may determine a function mapping based on the current orientation state and application state of wireless handheld device. The function mapping may map the first set of actions to right button 304 and left button 306. For example, the first set of actions may define volume controls of a phone call by mapping an action for increasing the volume to right button 304 and an action for decreasing the volume to left button 306.

As another non-limiting example, when wireless handheld device 300 is in a vertical position with right tilt orientation state (such as shown in FIG. 3B) and when the application mode of wireless handheld device 300 indicates that the phone application is active (i.e., indicating a phone mode), the controller of wireless handheld device 300 may determine another function mapping based on the current orientation state and application stat. The function mapping may map the second set of actions to right button 304 and left button 306. The second set of actions may define actions to be performed with respect to volume controls of a phone call by mapping an action for decreasing the volume to right button 304 and an action for increasing the volume to left button 306.

This discussion of the types of actions, software functions, application modes, and orientation states is merely exemplary. Other types and combinations of functions, application mode, and orientation states are considered to be within the scope of this disclosure.

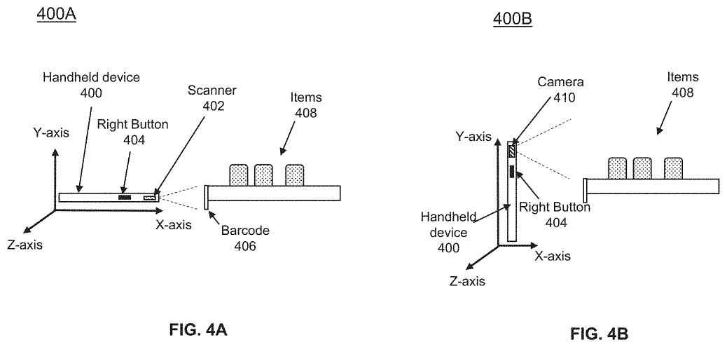

FIGS. 4A and FIG. 4B illustrate an example use of wireless handheld device 400 based on different orientation states and a software application supporting a second application mode (e.g., an inventory management mode), according to an exemplary embodiment. Wireless handheld device 400 may correspond to wireless handheld device 200 and/or wireless handheld device 300. As discussed above, device orientation states may further be associated with different application modes of a wireless handheld device. FIGS. 4A and 4B also illustrate an embodiment where the application mode of wireless handheld device is an inventory management mode. While FIGS. 4A-4B discusses wireless handheld device 400, it should be understood that in other embodiments, wireless handheld device 400 may be implemented as a handheld device without any wireless communication (i.e., lacking hardware components) or with its wireless capability disabled.

FIG. 4A illustrates wireless handheld device 400 in a horizontal orientation state which may be determined based on the position of wireless handheld device 400 with respect to the X, Y, and Z axes as discussed above. A controller in wireless handheld device 400 may detect that wireless handheld device 400 has transitioned into the horizontal orientation state from another orientation state or may simply determine the current orientation state without calculating any transitioning. The controller may further take into account the application mode of wireless handheld device. Based on the current orientation state and the application mode, the controller may configure right button 404 to perform a specific function based on a function mapping associated with the current orientation state and the application mode. In a non-limiting example, the application mode specify the inventory management mode and the specific function is based on this mode. When the device orientation is horizontal (as shown with respect to the X and Y axes in FIG. 4A), the controller of wireless handheld device 400 may determine that the inventory management mode requires operation of scanner 402 (which may correspond to scanner 212) and right button 404 may be configured to perform an action associated with a software function of scanner 402. Optionally, the left button (not shown in FIGS. 4A and 4B) may be configured to perform the same action, giving the user the option to hold the device in either hand and press the button with the holding-hand thumb. In this example, the software function may be transmitting a beam (e.g., a laser) from scanner 402 for the purpose of scanning barcode 406. Barcode 406 may provide information associated with items 408. The action may be to activate the beam. Accordingly, when wireless handheld device 400 is in a horizontal orientation state and the application mode indicates that the inventory management mode is active, a user pressing right button 404 would result in performing the scanning action of scanner 402.

FIG. 4B illustrates wireless handheld device 400 in a vertical orientation state which may be determined based on the position of wireless handheld device 400 with respect to the X, Y, and Z axes as discussed above. A controller in wireless handheld device 400 may detect that wireless handheld device 400 has transitioned into the vertical orientation state from another orientation state or may simply determine the current orientation state without calculating any transitioning. When the device orientation is vertical (as shown with respect to the X and Y axes in FIG. 4B), the controller of wireless handheld device 400 may determine that the inventory management mode requires operation of camera 410 (which may correspond to camera 202) and right button 404 may be configured to perform an action associated with a software function of camera 410. Optionally, the left button (not shown in FIGS. 4A and 4B) may be configured to perform the same action, giving the user the option to hold the device in either hand and press the button with the holding-hand thumb. In this example, the software function may be control of a shutter to take pictures of objects to be organized by the software application in inventory management mode, such as items 408. The action may be to activate the shutter in order to take the picture. Accordingly, when wireless handheld device 400 is in a vertical orientation state with the inventory management mode active, a user pressing right button 404 would result in performing the capture action of camera 410.

In an embodiment of FIGS. 4A and 4B, an approximately 90° rotation of the wireless handheld device 400 about its X axis may cause a transition from a horizontal device orientation state to a vertical device orientation state. A 90° rotation about any axis may be represented mathematically based on the following vector-dot product condition (based on the mathematical fact that the dot product of orthogonal vectors being equal to zero):

G^{BEFORE}·G^{AFTER}=(G_{X}^{BEFORE}*G_{X}^{AFTER}+G_{Y}^{BEFORE}*G_{Y}^{AFTER}+G_{Z}^{BEFORE}*G_{Z}^{AFTER})≈0

In this equation, G^{BEFORE} may represent the gravity unit vector during the horizontal device orientation state before wireless handheld device 400 is rotated. G^{AFTER} may represent the gravity unit vector into the vertical device orientation state after wireless handheld device 400 is rotated. G_{X} may represent the gravity unit vector along the x-axis, G_{y} may represent the gravity unit vector along the y-axis, and G_{Z} may represent the gravity unit vector along the z-axis. That is, G_{X}, G_{y}, and G_{Z} may be the components of the gravity unit vector in the frame of reference of the wireless handheld device.

As a non-limiting example, the orientation state transition criteria might be represented as follows:

−½<G^{BEFORE}·G^{AFTER}<+½
where the before and after gravity unit vectors (G^{BEFORE} and G^{AFTER}) may be measured in
predetermined intervals, such as less than one second apart. Such a transition criteria may depend on relative orientation rather than absolute orientation. Wireless handheld device 400 may store orientations in an orientation history. Relative orientation may be based on the stored orientations by considering a current orientation in relation to the stored orientations in the orientation history.

In some embodiments, it may be advantageous to condition transitions to one or more axes. For example, a rotation (e.g., 90°) may trigger a transition only if the rotation is about a specified axis such as the X axis. Determining that a rotation of wireless handheld device 400 is about its X axis, rather than some other axis, may be mathematically expressed using the vector cross product:

G^{BEFORE}×G^{AFTER}=(G_{Y}^{BEFORE}*G_{Z}^{AFTER}−G_{Z}^{BEFORE}*G_{Y}^{AFTER}, G_{Z}^{BEFORE}*G_{X}^{AFTER}G_{X}^{BEFORE}*G_{Z}^{AFTER}, G_{X}^{BEFORE}*G_{Y}^{AFTER}−G_{Y}^{BEFORE}*G_{X}^{AFTER})≈(±1 , 0 , 0)

As a non-limiting example, in addition to the orientation state transition criteria (−½<G^{BEFORE}·G^{AFTER}<½) discussed above, additional criteria corresponding to a requirement that the rotation is approximately about the X axis may further be specified to calculate the transition of wireless handheld device 400:

|G_{Y}^{BEFORE}*G_{Z}^{AFTER}−G_{Z}^{BEFORE}*G_{Y}^{AFTER}|>½

|G_{Z}^{BEFORE}*G_{X}^{AFTER}−G_{X}^{BEFORE}*G_{Z}^{AFTER}|>½

|G_{X}^{BEFORE}*G_{Y}^{AFTER}−G_{Y}^{BEFORE}*G_{X}^{AFTER}|<½

Similar principles may apply in embodiments in which the desired criteria includes rotation about the Y or Z axes. For example, the above equations may be adapted to condition transitions about the Y axes by replacing the subscript X with Y, Y with Z, and Z with X. If A is a unit vector about any axis of interest a 90° rotation about that axis may be recognized by the criteria |G^{BEFORE}×G^{AFTER}·A|≈1.

In some embodiments, a return from camera functionality to barcode scanning functionality within the inventory management mode may be triggered rotating wireless handheld device 400 from a vertical at approximately 90 degree angle device orientation back to an approximately horizontal device orientation. The foregoing equations discuss determining transitions to different assignments of button functions based not only on current device orientation state of wireless handheld device 400, but also on previous device orientation states. In these embodiments, device orientation states may be mapped to button actions to each physical button and to different application states. In other words, device orientation state is the only orientation condition for determining application mode and button action mapping.

In some embodiments, software actions are mapped to different device orientation states and the current application state of handheld device. In other words, both device orientation states and current application mode represent the orientation condition for determining the button action mapping.

FIGS. 5A and 5B illustrate example function maps mapping button functions to device orientation states, according to an exemplary embodiment. Function maps may define mappings between a device orientation state and functions to be assigned to specific buttons of a handheld device.

FIG. 5A provides table 500a which includes exemplary function maps 518a-518d for device orientation state 502. In FIG. 5A, device orientation state 502 and current application state 508 represent an orientation condition for the mapping actions to left button action 504 and right button action 506. In the example shown in FIG. 5A, current application mode 508 of wireless handheld device 200 may indicate that an inventory management application mode is currently active. In an embodiment, tables, such as table 500a, may be associated with multiple application modes. For example, table 500a may be associated with an application mode indicating a phone mode 516a and another application mode indicating the inventory management mode 516b.

In an embodiment, tables may be associated with a single application mode or multiple application modes. For example, table 500a, as shown, includes two application modes, namely a phone mode 516a and an inventory management mode 516b. In other embodiments, the software application may supports only one application mode. For example, a software application may have only a phone mode; for example, the software application may be a phone application for wireless handheld device 200. Different sets of actions may be mapped to the different orientation states for the single phone mode which would result in modification of table 500a (or a different table altogether). For example, there may be no actions mapped to for left button action 504 and right button action 506 when the device orientation state is horizontal face up 510c. As another example, a different set of actions such as selecting contacts or initiating phone calls may be mapped to left button action 504 and right button action 506. As another example, table 500a may be modified so that it is associated with an application having only a single application mode (inventory management mode) in which the programmable buttons either trigger a scan or do nothing depending on whether or not the device is approximately horizontal. While table 500a reflects a table for an application having a phone mode and an inventory management mode, one of ordinary skill in the art would understand that wireless handheld device 200 may include one or more tables associated with different applications installed on wireless handheld device 200. For example, there may be one or more tables associated with a phone software application, one or more tables associated with a media software application, one or more tables associated with a camera application, etc. Each of these tables may have different function maps that map device orientation states to different actions and software functions. For example, a table may be associated with a phone software application (e.g., the phone “app” installed with wireless handheld device 200, a phone application that has chat capability such as WhatsApp or Skype) that maps actions to one or more application modes of the phone software application. A phone application that has chat capability may have a first set of actions mapped to the phone mode of the phone software application and another set of actions mapped to the chat mode of the phone software application.

In an embodiment where two or more modes are supported within one software application, transitions between modes, and transitions of button function assignments within each mode, may be determined by device orientation and do not require the user to otherwise interact with software on wireless handheld device 200 such as by touching an icon on touch/display 208 to launch a new software application.

Returning to FIG. 5A, table 500a may map different software functions such as scanning barcodes using scanner 212 for an inventory management mode, taking pictures using camera 202 for an inventory management mode, or volume control for a phone mode. As a non-limiting example, a store employee may use an inventory management application that employs different hardware-based functions of wireless handheld device 200 such as reading barcodes to track inventory on store shelves and in the store stockroom, and talking to fellow store employees, all within the inventory management application and without otherwise interacting with software or the operating system such as by activating a new application via touch/display 208. Table 500a provides values for device orientation state 502, left button action 504 (such as for left button 206), right button action 506 (such as for right button 204), and, in this embodiment, current application mode 508. In this embodiment, the five orientation states of device orientation state 502 may include vertical with left tilt 510a, vertical with right tilt 510b, horizontal face up 510c, vertical 510d at approximately 90° 510d, and horizontal face down 510e; table 500a may also indicate that current application mode 508 of wireless handheld device is in either phone application state 516a (for vertical with left tilt 510a or vertical with right tilt 510b) or inventory management application 516b (for horizontal face up 510c or vertical at approximately 90° 510d).

Referring to both table 500a, mapped actions for some embodiments are now discussed. Function map 518a may map actions for a software function to device orientation state 502 and current application state 508. In other words, device orientation state 502 and current application state 508 may represent orientation conditions for triggering the configuration of right button 204 and left button 206 to right button action 506 and left button action 504, respectively. In this embodiment of function map 518a, the software function is volume control, device orientation state 502 is vertical with left tilt 510a, and current application mode 508 is in phone application state 516a. Accordingly, in function map 518a, volume down 512a may be mapped to left button action 504 and volume up 514a may be mapped to right button action 506.

Referring again to table 500a, function map 518b may map actions for a software function to device orientation state 502 and current application mode 508. In this embodiment, the software function is volume control, device orientation state 502 is vertical with right tilt 510b, and current application mode 508 is in phone application mode 516a. Accordingly, in function map 518b, volume up 512b may be mapped to left button action 504 and volume down 514b may be mapped to right button action 506.

Function map 518c may map actions for a software function to device orientation state 502 and current application mode 508. In this embodiment, the software function is a barcode scan control, device orientation state 502 is horizontal face up 510c, and current application mode 508 is inventory management state 516b. Accordingly, in function map 518c, both left button action 504 and right button action 506 may be mapped to scan barcode 512c.

Function map 518d may map actions for a software function to device orientation state 502 and current application mode 508. In this embodiment, the software function is a camera shutter control, device orientation state 502 is vertical at approximately 90° 510d, and current application mode 508 is inventory management state 516b. Accordingly, in function map 518d, both left button action 504 and right button action 506 may be mapped to camera shutter control (take picture) 512d. FIG. 4B illustrates a case where the device orientation state 502 is vertical at approximately 90° 510d.

Again referring to both table 500a, function map 518e may map actions for a software function to device orientation state 502 and current application state 508. In this embodiment, there is no software function when device orientation state 502 is horizontal face down 510d and no active application mode for current application mode 508. In other words, when wireless handheld device 200 is face down, such as on a table, there are no actions mapped to left button action 504 and right button action 506. This may be advantageous as a user picking up a handheld device that is face down on a table generally does not yet seek to activate any button, and yet is at risk of unintentionally pressing a button while picking up the device.

An exemplary use case is discussed. First, the store employee may use wireless handheld device 200 as a phone to communicate with fellow employees. In an embodiment, this may be done with the aid of a software application that includes a phone mode. The employee may launch the software application, such as by touching the appropriate icon, or the desired software application may initiated as a default during device power up. Current application mode 508 is in phone mode 516a in order for wireless handheld device 200 to operate as phone. The software application may always be in phone mode (e.g. if the application has no other modes such as inventory management mode), or may enter phone mode for certain orientation states. For example, table 500a may map the vertical with left tilt 510a orientation state to the phone mode so that the phone mode is launched when wireless handheld device 200 is placed in that device orientation state. Accordingly, when held against the store employee's ear, the handheld device is in the appropriate device orientation state and functions as a phone via the phone mode. When the device is in the appropriate device orientation state—vertical with left tilt 510a or vertical with right tilt 510b—actions of left button 206 and right button 204 are mapped to control volume which would allow the store employee may adjust the speaker volume during the phone conversation.

Continuing the example above, the store employee may finish the phone conversation, and then use wireless handheld device 200 to scan barcodes of shelved items. To maximize the efficient use and user friendliness of the active software application, it is advatageous for it to change application modes of the software application without requiring the employee to find and select and icon presented on the touch/display area 208 in order to activate an inventory management mode that includes a software function for barcode scanning. In an embodiment, mode transitions may be triggered by a change in orientation state. For example, right button 204 and/or left button 206 may be reprogrammed so that barcode scans can be easily activated by a thumb on one of those side buttons after having entered a mode supporting a bar code scanning function to make the experience more ergonomic for the store employee.

While scanning barcodes, the store employee may hold wireless handheld device 200 at approximately horizontal device orientation so that scanner 212 is aimed at barcodes to be scanned and with touch/display area 208 facing up so that the display can be viewed by the store employee. Depending on whether the device is being held with a right hand or a left hand, use of either right button 204 or left button 206 to control the barcode software function will be more ergonomic. A barcode scan action may be assigned to both left and right side buttons when device orientation state 502 is horizontal face up 510c. Conversely, if device orientation state 502 is horizontal face down 510d, it may be assumed that wireless handheld device is not being used as either a barcode scanner or a phone; it may be appropriate to disable the side buttons, assigning them no function to prevent accidental button touches.

The number of items may be relevant to the inventory management application while scanning bar codes of a number of idential items on a shelf. There may a need for the store employee to take a picture of the inventory such as when there are multiple identical items on a shelf so that the store employee does not need to individually scan or count all identical items. The inventory management application may further be configured to perform optical character recognition on the picture to automate counting of the items on the shelf. For this purpose, as is illustrated in FIG. 4B, the user may rotate wireless handheld device 200 by approximately 90° about the X axis so that camera 202 rather than scanner 212 is aimed at the items. Such a rotation may trigger a transition to the device orientation state of vertical at approximately 90° 510d. Depending on whether the device is being held with a right hand or a left hand, use of either right button 204 or left button 206 to control the camera function (shutter activation) will be more ergonomic. Accordingly the take picture action may be assigned to both left and right side button actions 504 and 506, respectively, when device orientation state 502 is vertical at approximately 90° 510d.

FIG. 5B illustrates the possibility that within a particular software application, the orientation state my determine more than just the functions of programmable hardware buttons, but also other hardware and software settings. Table 500b of FIG. 5B is similar to table 500a of FIG. 5A. FIG. 5B depicts table 500b with exemplary function maps 518e-518h for mapping button functions to device orientation state 502 and mode 520, according to an exemplary embodiment. In FIG. 5B, only device orientation state 502 represents an orientation condition for the mapping actions to left button action 504 and right button action 506 and mode 520 of wireless handheld device 200. In the example shown in FIG. 5B, mode 520 references a speaker mode of wireless handheld device 200 but may control modes of other components of wireless handheld device 200 (such as touch/display area 208, camera 202). Wireless handheld device 200 may have a speaker that can either function as a loudspeaker or as a phone speaker. The reason to have separate settings for the speaker is that there needs to be different volumes for phone mode 522a, when the device may be against an ear, and a combined phone and inventory management mode 524a in which the user may continue bar code scanning and at the same time carry on a phone conversation with loudspeaker level speaker volumes. Maximum speaker volume (at “loudspeaker” volumes) may be greater in combined phone and inventor management mode 524a than in phone mode 522a. Having a lower maximum speaker volume in phone mode 522a may help avoid hearing damage. The speaker may be implemented in phone mode 522a when a call is received, but changes to combined phone and inventory management mode 524a when the user no longer has the device next to an ear and either lays the device face-up on a table top or may even return to scanning items with the device's bar code scanner. In conventional phone systems, the transition to increased “loudspeaker” volumes is activated by the user touching an icon on the touch/display area 208. For improved efficiency and user friendliness, it is advantageous if the transition to “loudspeaker” volumes is triggered by a change in orientation state without requiring the user to interact with software or the operating system such as by touching an icon on touch/display 208. In an embodiment, changes in modes may occur based on device orientation state 502. For example, wireless handheld device 200 in vertical with left tilt 510a may cause phone mode 522a to be automatically triggered; similarly, wireless handheld device 200 in horizontal face up 510c may trigger combined phone and inventory management mode 524a.

Mapped actions for this embodiment are now discussed. Function map 518e may map actions for a software function to device orientation state 502. In other words, device orientation state 502 may represent an orientation condition for triggering the configuration of right button 204 and left button 206 to right button action 506 and left button action 504, respectively. Device orientation state 502 may also trigger configuration of mode 520, which in this embodiment, relates to a phone mode of wireless handheld device 200 that not only influences the functions of programmable hardware buttons, but also affects speaker volume settings. In this embodiment of function map 518e, the software function includes volume control, and device orientation state 502 is vertical with left tilt 510a. Accordingly, in function map 518a, volume down 512a may be mapped to left button action 504, volume up 514a may be mapped to right button action 506, and mode 520 is configured to phone mode 522a.

Function map 518f may map actions for a software function to device orientation state 502. In this embodiment of function map 518f, the software function includes volume control, and device orientation state 502 is vertical with right tilt 510b. Accordingly, in function map 518f, volume down 514b may be mapped to right button action 504, volume up 512b may be mapped to right button action 506, and mode 520 is configured to phone mode 522a.

Function map 518g may map actions for a software function to device orientation state 502. In this embodiment of function map 518g, the software function is a barcode scan control and device orientation state 502 is horizontal face up 510c. Accordingly, in function map 518g, both left button action 504 and right button action 506 may be mapped to scan barcode 512c and mode 520 is configured to combined phone and inventory management mode 524a which may also include volume control functions.

Function map 518h may map actions for a software function to device orientation state 502. In this embodiment, there is no software function when device orientation state 502 is horizontal face down 510d. In other words, when wireless handheld device 200 is face down, such as on a table, there are no actions mapped to left button action 504 and right button action 506 and no mode is configured for mode 520.

FIGS. 5C and 5D illustrate example orientation maps mapping device orientation to device orientation states, according to an exemplary embodiment. Exemplary orientation maps of FIGS. 5C and 5D may be used to determine values for device orientation state 502.

FIG. 5C includes table 500c with exemplary orientation maps 530a-530d. Orientation maps 530a-530d define mappings for device orientation (angle) 526 and device orientation (unit vector) 528 to device orientation state 502. In other words, different values for device orientation state 502 may be determined based on device orientation represented by angles, or by unit vector, or by any other mathematical representation of the same orientation information; different device orientations may therefeore be uniquely assigned a corresponding device orientation state (in contrast, FIG. 5D illustrates a case with hysteresis where the mapping is not unique). The optimal device-orientation to orientation-state mapping may vary with the purposse and design of each software application. Furthermore the exact design of wireless handheld device 200 may influence the details for orientation-state mapping and therefore may be adjusted as needed. Even within the same software application and the same exact hardware design, the orientation-state mapping may be customized to a particular user. There may be different tables that map different device orientations to corresponding device orientation states where each table is associated with a particular software application, a particular hardware version, or a particular user of wireless handheld device 200.

Mapped actions for this embodiment are now discussed. The values of device orientation (angle) 526 and device orientation (unit vector) 528 are merely exemplary. Table 500c may be configured to map any device orientation values to device orientation state 502 as needed based on the particular software application, particular type of wireless handheld device 200, or any other factors.

Orientation map 530a may map device orientation values to device orientation state 502. When controller of wireless handheld device 200 detects a device orientation (angle) 526 of α>90° & 45°<γ<135° or the mathematically equivalent device orientation (unit vector) 528 of Gx<0 & −0.707<Gz<+0.707, or any other equivalent mathematical relationships, the controller may configure device orientation state 502 to vertical with left tilt 510a.

Orientation map 530b may map device orientation values to device orientation state 502. When controller of wireless handheld device 200 detects a device orientation (angle) 526 of α>90° & 45°<γ<135° or equivalently a device orientation (unit vector) 528 of Gx>0 & −0.707<Gz<+0.707, the controller may configure device orientation state 502 to vertical with right tilt 510b.

Orientation map 530c may map device orientation values to device orientation state 502. When controller of wireless handheld device 200 detects a device orientation (angle) 526 of γ<135° and/or a device orientation (unit vector) 528 of Gz <−0.707, the controller may configure device orientation state 502 to horizontal face up 510c.

Orientation map 530d may map device orientation values to device orientation state 502. When controller of wireless handheld device 200 detects a device orientation (angle) 526 of γ<45° and/or a device orientation (unit vector) 528 of G_{Z}>+0.707, the controller may configure device orientation state 502 to horizontal face down 510d.

FIG. 5D includes table 500d with exemplary orientation maps 530e-530h that provide a buffer for transitioning between different device orientation states. In some embodiments, a buffer or use of hysteresis when calculating device orientation state 502 may increase the accuracy of the calculation and improve the smoothness of the operation by preventing jitter between changes in device orientation state 502. Hysteresis may also be referred to as “debouncing” in electrical engineering terms. Consider an example where wireless handheld device 200 is currently in a phone application state and being held with very little tilt (e.g., α≈90°). If, during the call, the values of the angle α drift between 85° and 95°, device orientation state of wireless handheld device 200 may switch based on the change in angle α which could cause mapped actions of right button 204 and left button 206 to be constantly swapped. Introducing a buffer such as described in table 500d would help in such a situation. Put another way, actions of physical buttons may be configured to not change until there has been a significant change in device orientation.

Table 500d illustrates an example of device-orientation to orientation-state mapping with buffering. Device orientation transition angles 532 provides criteria to transition from one device orientation state to another device orientation state. Device orientation hold angles 534 provides criteria for remaining in a device orientation state. In other words, for a given orientation state, the transition angle thresholds for transitioning into the orientation state may differ from hold angle thresholds for transitioning out of the orientation state. Table 500d may be regarded as a buffered version of table 500c. Table 500d, which maps orientations to orientation states, may work in conjunction with tables 500a or table 500b, which maps orientation states to button actions and software application modes. The values of device orientation transition angles 523 and device orientation hold angles 534 are merely exemplary. Table 500d may be configured to map any device orientation values to device orientation state 502 as needed based on the particular software application, particular type of wireless handheld device 200, or any other factors.

Orientation map 530e may specify values for device orientation transition angles 532 for wireless handheld device 200 to transition into the orientation state vertical with left tilt 510a and also values for device orientation hold angles 534 for wireless handheld device 200 to begin transitioning out of vertical with left tilt 510a. As a non-limiting example, if device orientation state 502 is initially vertical with right tilt 510b, and the angle α increases to satisfy α>100°, then wireless handheld device 200 may transition into orientation state vertical with left tilt 510a. Similarly, if device orientation state 502 is initially horizontally face up 510c or horizontally face down 510d, and the angle γ increases to satisfy 55°<γ<125°, then wireless handheld device 200 may transition into the orientation state vertical with left tilt 510a or the orientation state vertical with right tilt 510b depending on whether the angle α is larger or less than 90°. In table 500d, these transition angle criteria are represented in abbreviated form by “α>100° OR 55°<γ<125°”. Once device orientation state 502 is vertical with left tilt 510a, device orientation state 502 of wireless handheld device 200 remains held in vertical with left tilt 510a as long as device orientation angles α and γ continue to satisfy both the condition α>80° and the condition 35°<γ<145°. When these conditions are no longer satisfied, then wireless handheld device 200 may initiate a transition out of vertical with left tilt 510a. In particular, when α>80° is no longer true, wireless handheld device may have a right tilt, device orientation state 502 may transition to vertical with right tilt 510b, and when the condition 35°<γ<145° is no longer true (device orientation has become more horizontal than vertical), device orientation state 502 may transition to horizontal face up 510a or horizontal face down 510d. In table 500d, these hold angle criteria are represented in abbreviated form by “α>80° AND 35°<γ<145°”. In some embodiments, there may be multiple criteria based on the current device orientation. For example, the criteria for transitioning into the vertical with left tilt 510a is α>100° if the transition is from the vertical with right tilt 510b; if the transition is from a horizontal orientation state (such as horizontal face up 510c) to a vertical state (such as vertical with left tilt 510a), then the transition criteria is 55°<γ<125°.

Orientation map 530f may specify values for device orientation transition angles 532 for wireless handheld device 200 to transition into vertical with right tilt 510b and values for device orientation hold angles 534 for wireless handheld device 200 to begin transitioning out of vertical with right tilt 510b. As a non-limiting example, if device orientation is detected to fall within α<80° OR 55°<γ<125°, then device orientation state 502 of wireless handheld device 200 may transition into vertical with right tilt 510b and may remain in this orientation state as long as the device orientation is within α<100° AND 35°<γ<145°. When these conditions are no longer true, wireless handheld device 200 may initiate a transition out of vertical with right tilt 510b. In some embodiments, there may be multiple criteria based on the current device orientation. For example, the criteria for transitioning into the vertical with right tilt 510a is a <80° if the transition is from the vertical with left tilt 510a; if the transition is from a horizontal orientation state (such as horizontal face up 510c) to a vertical state (such as vertical with right tilt 510b), then the transition criteria is 55°<γ<125°.

Orientation map 530g may specify values for device orientation transition angles 532 for when device orientation state 502 of wireless handheld device 200 is to transition into horizontal face up 510c and values for device orientation hold angles 534 for wireless handheld device 200 to begin transitioning out of horizontal face up 510c. As a non-limiting example, if device orientation is detected to fall within γ>145°, then wireless handheld device 200 transitions into horizontal face up 510c and remains held in that orientation state as long as the device orientation continues to meet the criteria γ>125°. When the condition γ>125° is no longer satisfied, then wireless handheld device 200 may transition out of the orientation state horizontal face up 510c. In other words, wireless handheld device 200 will not transition to the horizontal face-up orientation state until the angle y exceeds 145°. But once in the horizontal face-up orientation state, there will be no return to a vertical orientation state until the angle y drops below 125°.

Orientation map 530h may specify values for device orientation transition angles 532 for wireless handheld device 200 to transition into horizontal face down 510d and values for device orientation hold angles 534 for wireless handheld device 200 to begin transitioning out of horizontal face down 510d. As a non-limiting example, if device orientation is detected to fall within γ<35°, then wireless handheld device 200 transitions into horizontal face down 510d and remains in that orientation state as long as the device orientation is within γ<55°. When the condition γ<55° is no longer true, the wireless handheld device 200 may initiate a transition out of horizontal face down 510d.

FIGS. 1-5B depicts a right physical button located on the right side of a device and a left physical button located on the left side of the device. However, embodiments regarding the locations of physical buttons are not limited to merely the right and left sides of a device but may be implemented at any side of the device. It will be apparent to one skilled in the art that similar concepts may apply to any device with a first physical button located on a first side of the device and a second physical button located on a second side of the device where the first and second sides may be any side of the device, not merely the left and right sides of a device as depicted in FIGS. 1-5B. For example, in an embodiment, the first side may be a front side and the second side may be a back side; in another embodiment, the first side may be a top side and the second side may be a back side; in another embodiment, the first side may be a left side and the second side may be a back side. Accordingly, embodiments of the handheld device are not limited to implementing buttons merely on the left and right side of the device, or necessarily on opposing sides of the device, but any side of the device. In further embodiments, the first side and the second side may be one and the same side. Regardless of which sides the physical buttons are located, the functions of the physical buttons may be a function of the orientation state of the device.

As a non-limiting example, an embodiment may include a handheld device in the shape of a cube with a physical programmable button on each of its six sides. The handheld device may further include an orientation sensor. The six sides of the handheld device may be numbered 1 through 6. The device may have six orientation states corresponding to which of the six sides is facing most upward relative to the orientation of the other sides. For example, orientation state 1 may correspond to side 1 being uppermost and orientation state 2 corresponds to side 2 being uppermost. The device may be programmed so that in orientation state N (where N is 1, 2, 3, 4, 5 or 6), only the physical button on side N is active while all other buttons are inactive. The device may implement a counter in which a count is incremented each time the active physical button (the one on top) is depressed. Such a counting device could be used by a tour guide counting the number of tourists returning to a tour bus by depressing the top button each time a tourist enters a bus. In this implementation, it would not matter which side of the device is facing upward because each of the physical buttons may be implemented to take the same action (taking a count) and any physical button on the uppermost side will be active.

Accordingly, the handheld device of FIGS. 1-5B is not limited to the devices depicted in the figures but may be any time of handheld device on which buttons are implemented on various sides of the device. There are many other possibilities in which there is at least a first side and second side with first and second physical buttons and the first and second sides need not be right and left sides.

Moreover, although FIGS. 1-5B also depict the handheld device as a wireless handheld device, one skilled in the art will understand that other embodiments of the disclosure may be implemented as a handheld device without any wireless capabilities (or with its wireless capabilities disabled). As a non-limiting example, a handheld device that lacks wireless capabilities may be deployed at a park or museum with different points of interest marked and numbered. The handheld device may be a device that lacks any wireless communication capability for reduced cost and extended battery life or may be a device with its wireless communication capability disabled to prevent misuse. At each point of interest (in either the park or the museum), the user may input the number (or some other identifier) associated with the point of interest. The user may then put the handheld device next to his ear, as one would do during a call on a smartphone, and listen to relevant information about the point of interest. In this embodiment, the handheld device stores all relevant information obviating any need for wireless communication (e.g., with a server).

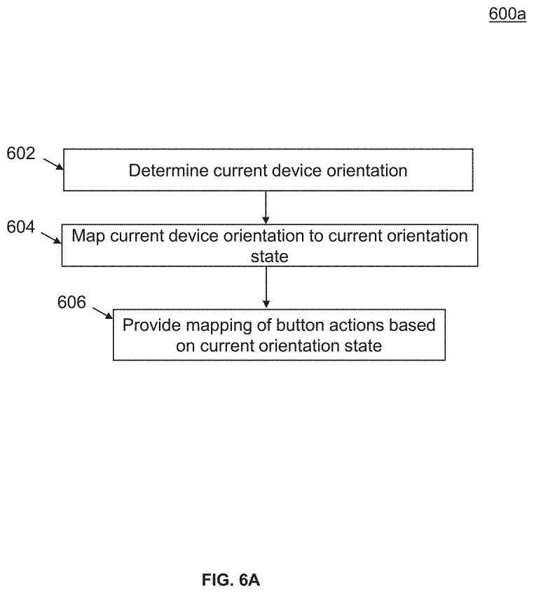

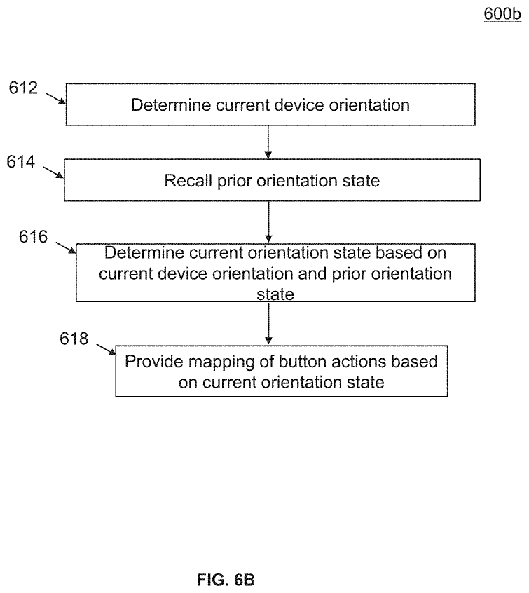

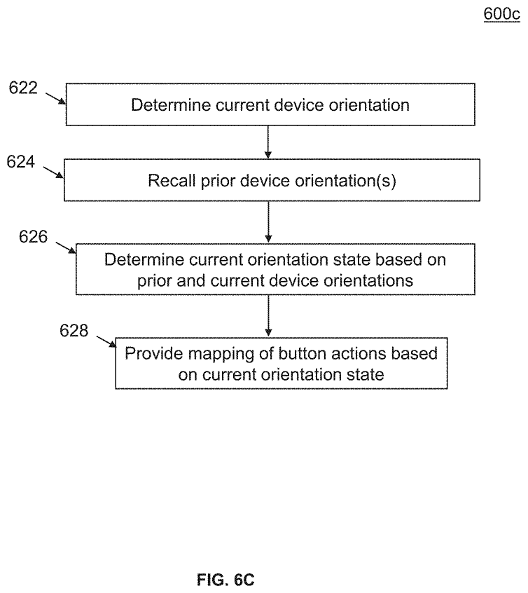

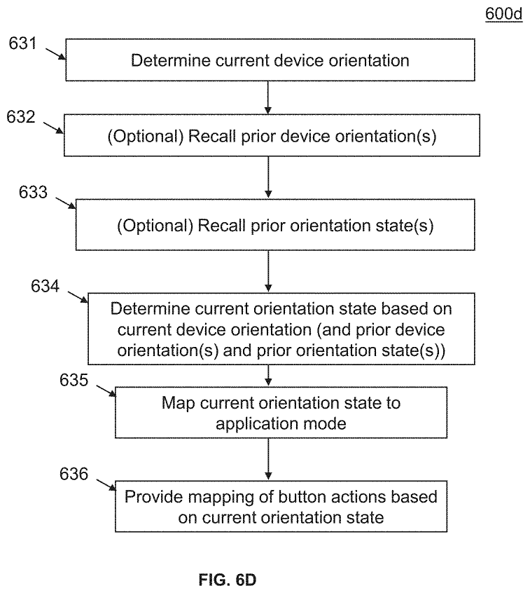

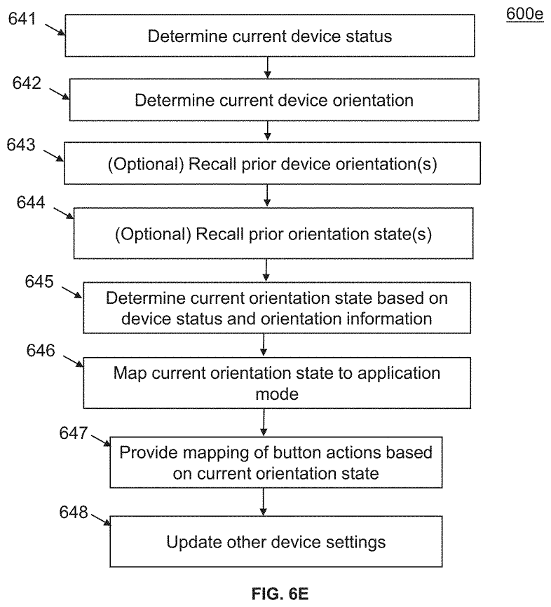

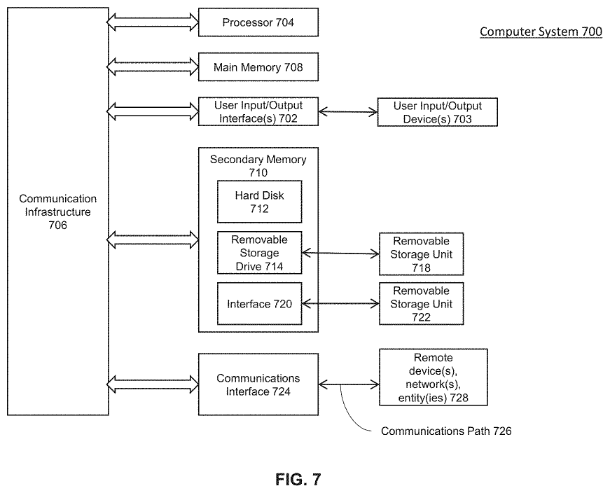

FIGS. 6A-E illustrates a flowchart for updating functions of buttons of a handheld device based on device orientation, according to an exemplary embodiment of the disclosure. As a non-limiting example with regards to FIGS. 2 and 5A-5D, one or more processes described with respect to FIGS. 6A-E may be performed by a controller in a wireless handheld device (e.g., wireless handheld device 200 of FIG. 2) to configure actions performed by physical buttons using function maps based on orientation conditions of the wireless handheld device. In such an embodiment, the controller of wireless handheld device 200 may execute code in memory to perform certain steps of methods 600a-e of FIGS. 6A-E. While methods 600a-e of FIG. 6A-E will be discussed below as being performed by wireless handheld device 200, other devices may store the code and therefore may execute methods 600a-e by directly executing the code. Accordingly, the following discussion of methods 600a-e will refer to FIGS. 2 and 5A-5D as an exemplary non-limiting embodiment of methods 600a-e. For example, methoda 600a-e may be executed on any computing device, such as, for example, the computer system described with reference to FIG. 7 and/or processing logic that may comprise hardware (e.g., circuitry, dedicated logic, programmable logic, microcode, etc.), software (e.g., instructions executing on a processing device), or a combination thereof. Moreover, it is to be appreciated that not all steps may be needed to perform the disclosure provided herein. Further, some of the steps may be performed simultaneously or in a different order than shown in FIGS. 6a-e, as will be understood by a person of ordinary skill in the art.

Referring to FIG. 6A, method 600a determines the functions of programmable hardware buttons (e.g., right button 204, left button 206) based on the orientation of wireless handheld device 200. At step 602, a controller of wireless handheld device 200 may determine the current orientation of wireless handheld device 200. In an embodiment, this determination may be via measurements taken by orientation sensor similar to what is described above in FIGS. 3A, 3B, 4A, 4B, and 5A-D. These measurements may be digitally provided to the software application in a mathematically convenient format such as an expression comprising of angles α, β and γ or their cosines.

At step 604, the current device orientation may be mapped to a current orientation state, which may be one of a discrete set of possible orientation states such as those described above with respect to FIGS. 5C-D which provide examples of different mappings to orientation states.

At step 606, actions may be mapped to the physical buttons of wireless handheld device based on the current orientation state. Examples of these mappings are described above with respect to FIGS. 5A-D with respect to an inventory management application having two different application modes (a phone mode and an inventory management mode).

It is to be understood that method 600a may include additional optional steps not explicitly shown in FIG. 6A. For example, after step 670, method 600a may return to step 620 as part of a monitoring operation where controller of wireless handheld device 200 may continue monitoring orientations of wireless handheld device 200 and updating actions of right button 204 and left button 206 based on any changes to the device orientation. As another example, method 600a may return to step 620 when the current orientation state is the same as a prior orientation state. As another example, method 600a may include initialization steps (preceding step 620) when a software application or “app” using method 600a is started. These and other additions to the flowchart of FIG. 6A will be apparent to a software engineer skilled in the art. Similar comments apply to methods 600b-e of FIGS. 6B-E.

Referring to FIG. 6B, method 600b determines the functions of programmable hardware buttons (e.g., right button 204, left button 206) based on the orientation of wireless handheld device 200 as well as a prior orientation state of wireless handheld device 200. For example, method 600b may relate to the hysteresis feature discussed with respect to FIG. 5D. In step 612 a controller of wireless handheld device 200 may determine the present device orientation of wireless handheld device 200.

At step 614, the controller may recall a prior orientation state. Prior orientation states may be stored in a memory of wireless handheld device 200. A prior orientation state may refer to any prior orientation states of wireless handheld device 200 including the orientation state immediately preceding the current orientation state. For example, if a user shifts wireless handheld device 200 from a horizontal face down orientation state to a vertical with a right tilt orientation state, then the prior orientation state is the horizontal face down orientation state and the current orientation state is the vertical with a right tilt orientation state.

In an embodiment, the device orientation state is not stored (or determined) unless wireless handheld device 200 remains in that orientation for a threshold amount of time. This condition may be useful to prevent storing every orientation state as wireless handheld device 200 transitions from one orientation to another (i.e., there may be any number of intervening orientations or orientation states). In the example discussed above, as wireless handheld device 200 transitions from horizontal face down orientation state to vertical with a right tilt orientation state, it may first transition to a horizontal face up orientation state (i.e., user turns wireless handheld device 200 over), and then to vertical at approximately 90° (i.e., user begins to bring the phone up), and then finally to the vertical with a right tilt orientation state. In an embodiment, only the beginning and end orientation states are stored; this may be determined by a threshold period of time that the device remains in the orientation state. In another embodiment, all orientation states are stored along with the period of time that wireless handheld device remained in that orientation state.

At step 616, the controller may determine the current orientation state based on both the current device orientation and the previously determined orientation state. Once the current orientation state has been determined, at step 618, the controller may provide the mapping of button actions to the physical buttons (e.g., right button 204, left button 206) based on the current orientation state as discussed above with respect to step 606.

Referring to FIG. 6C, method 600c determines the functions of programmable hardware buttons based on the current and prior device orientations of wireless handheld device 200. For example, method 600c may apply when determining relative orientation transitions such as vertical with approximately 90° from scanning to camera picture taking illustrated in FIGS. 4A-B and FIG. 5A.

At 622, the controller of wireless handheld device may determine the current device orientation. At step 624, the controller of wireless handheld device 200 may recall one or more previously determined device orientations. Prior device orientation states may be stored in a memory of wireless handheld device 200. A prior device orientation may refer to any prior device orientation state of wireless handheld device 200 including the device orientation immediately preceding the current orientation state. Device orientations may be stored in memory in a similar manner discussed with respect to orientation states above.

At step 626, controller may determine a current orientation state based on both prior and current device orientations. Once the current orientation state has been determined, at step 628, the controller may provide a mapping of button actions based on the current orientation state.

Referring to FIG. 6D, method 600d may determine the functions of programmable hardware buttons based on the current device orientation of wireless handheld device 200. Method 600d may determine both button functions and an application mode associated with a current orientation state of wireless handheld device. For example, both a phone mode and an inventory mode are discussed in connection with FIG. 5A. At 631, the controller may determine the current device orientation. At step 632, the controller may optionally recall one or more previously determined device orientations (similar to step 624 of FIG. 6C). At step 633, the controller may optionally recall one or more previously determined orientation states (similar to step 614 of FIG. 6B). At step 634, the controller may utilize the current device orientation and optionally, prior device orientations and prior orientation states to determine a current orientation state. Once the present orientation state has been determined, at step 635, the controller may determine an application mode for the software application, such as application modes discussed with respect to FIG. 5A. Finally method 600d, at step 636, the controller may provide a mapping of button actions based on the current orientation state.

Referring to FIG. 6E, method 600e provides a further generalization in which other aspects of device status in addition to device orientation influence resulting states, and resulting states may further influence device status or settings of wireless handheld device. At step 640, wireless handheld device 200 may determine a device status beyond device orientation. Examples of device status may include inputs from other sensors within wireless handheld device 200 such as an accelerometer, ambient light sensor, a sensor of the specific absorption rate (SAR) of radio-frequeny waves, microphone and camera (such as camera 202). Device status may also include current settings of wireless handheld device 200 such as current volume and brightness of the touch/display area 208. Device status may also be calculated based on these measurements to determine environmental conditions surrounding wireless handheld device 200 such as whether wireless handheld device 200 is in a user's pocket, lying flat on a table, currently being used by a user other than the owner of wireless handheld device 200, etc.

At step 642, the controller of wireless handheld device 200 may determine a current device orientation (similar to step 631 of FIG. 6D). At step 643, the controller may optionally recall one or more previously determined device orientations (similar to step 624 of FIG. 6C). At step 644, the controller may optionally recall one or more previously determined orientation states (similar to step 614 of FIG. 6B). At step 645, the controller may determine a current orientation state based on the current device status and current device orientation and optionally, the prior device orientations and prior orientation states. In this embodiment, orientation state may be based on solely on device status independently of device orientation. Once the current orientation state has been determined, at step 646, the controller may determine an application mode for the software application based on the current orientation state. At step 647, the controller may provide a mapping of button actions based on the current orientation state. Finally, at step 680, the controller may update other device settings based on the orientation state such as changes to speaker volume settings and screen brightness settings.

Various embodiments can be implemented, for example, using one or more well-known computer systems, such as computer system 700 shown in FIG. 7. Computer system 700 can be any well-known computer capable of performing the functions described herein such as touchscreen device 110 and/or controller 120.

Computer system 700 includes one or more processors (also called central processing units, or CPUs), such as a processor 704. Processor 1604 is connected to communication infrastructure 706 (e.g., a bus). One or more processors 704 may each be a graphics processing unit (GPU). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc. Computer system 700 also includes user input/output device(s) such as monitors, keyboards, pointing devices, etc., that communicate with communication infrastructure 806 through user input/output interface(s) 702.

Computer system 700 also includes a main or primary memory 708, such as random access memory (RAM). Main memory 708 may include one or more levels of cache. Main memory 708 has stored therein control logic (i.e., computer software) and/or data. Computer system 700 may also include one or more secondary storage devices or memory 710. Secondary memory 710 may include, for example, a hard disk drive 712 and/or a removable storage device or drive 714. Removable storage drive 714 may be a floppy disk drive, a magnetic tape drive, a compact disk drive, an optical storage device, tape backup device, and/or any other storage device/drive.

Removable storage drive 714 may interact with a removable storage unit 718. Removable storage unit 718 includes a computer usable or readable storage device having stored thereon computer software (control logic) and/or data. Removable storage unit 718 may be a floppy disk, magnetic tape, compact disk, DVD, optical storage disk, and/ any other computer data storage device. Removable storage drive 714 reads from and/or writes to removable storage unit 718 in a well-known manner.

According to an exemplary embodiment, secondary memory 710 may include other means, instrumentalities or other approaches for allowing computer programs and/or other instructions and/or data to be accessed by computer system 700. Such means, instrumentalities or other approaches may include, for example, a removable storage unit 722 and an interface 720. Examples of the removable storage unit 722 and the interface 720 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 700 may further include a communication or network interface 724. Communication interface 724 enables computer system 700 to communicate and interact with any combination of remote devices, remote networks, remote entities, etc. (individually and collectively referenced by reference number 728). For example, communication interface 724 may allow computer system 700 to communicate with remote devices 728 over communications path 726, which may be wired, and/or wireless, and which may include any combination of LANs, WANs, the Internet, etc. Control logic and/or data may be transmitted to and from computer system 700 via communication path 726.

In an embodiment, a tangible, non-transitory apparatus or article of manufacture comprising a tangible, non-transitory computer useable or readable medium having control logic (software) stored thereon is also referred to herein as a computer program product or program storage device. This includes, but is not limited to, computer system 700, main memory 708, secondary memory 710, and removable storage units 718 and 722, as well as tangible articles of manufacture embodying any combination of the foregoing. Such control logic, when executed by one or more data processing devices (such as computer system 700), causes such data processing devices to operate as described herein.

The foregoing description, for purposes of explanation, used specific nomenclature to provide a thorough understanding of the disclosure. However, it will be apparent to one skilled in the art that specific details are not required in order to practice the disclosure. Thus, the foregoing descriptions of specific embodiments of the disclosure are presented for purposes of illustration and description. They are not intended to be exhaustive or to limit the disclosure to the precise forms disclosed; obviously, many modifications and variations are possible in view of the above teachings. The embodiments were chosen and described in order to best explain the principles of the disclosure and its practical applications, they thereby enable others skilled in the art to best utilize the disclosure and various embodiments with various modifications as are suited to the particular use contemplated. It is intended that the following claims and their equivalents define the scope of the disclosure.

Based on the teachings contained in this disclosure, it will be apparent to persons skilled in the relevant art(s) how to make and use embodiments of the disclosure using data processing devices, computer systems and/or computer architectures other than that shown in FIG. 7. In particular, embodiments may operate with software, hardware, and/or operating system implementations other than those described herein.

It is to be appreciated that the Detailed Description section, and not the Abstract section, is intended to be used to interpret the claims. The Abstract section may set forth one or more, but not all exemplary embodiments, of the disclosure, and thus, are not intended to limit the disclosure and the appended claims in any way.

The disclosure has been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

It will be apparent to those skilled in the relevant art(s) that various changes in form and detail can be made therein without departing from the spirit and scope of the disclosure. Thus the disclosure should not be limited by any of the above-described exemplary embodiments. Further, the claims should be defined only in accordance with their recitations and their equivalents.

1. A handheld device comprising:
a first physical button located on a first side of the handheld device, wherein the first physical button is configured to perform a first action related to a first software function;
a second physical button located on a second side of the handheld device, wherein the second physical button is configured to perform a second action related to a second software function; and
a controller configured to:
calculate an orientation of the handheld device;
identify a device orientation state associated with the orientation;
determine an orientation condition based on the device orientation state;
determining a current application mode of an application installed on the handheld device, wherein the application includes the current application mode and a second application mode;
configure, based on the orientation condition and the current application mode, the first physical button to perform a third action related to the first software function; and
configure, based on the orientation condition and the current application mode Gtate, the second physical button to perform a fourth action related to the second software function.

2. The handheld device of claim 1, wherein the first side and the second side represent opposing vertical sides of the handheld device.

3. The handheld device of claim 1, wherein the first software function and the second software function are defined by the current application mode.

4. The handheld device of claim 3, wherein the current application mode specifies an application currently being displayed by the handheld device and both the first software function and the second software function control functions of the application.

5. The handheld device of claim 1, wherein the first action is equivalent to the fourth action and the second action is equivalent to the third action.

6. The handheld device of claim 5, wherein the first software function is equivalent to the second software function.

7. The handheld device of claim 6, wherein the first software function controls a volume of the handheld device, the second software function controls the volume of the handheld device, the first action increases the volume of the handheld device, the second action decreases the volume of the handheld device, the third action decreases the volume of the handheld device, and the fourth action decreases the volume of the handheld device.

8. The handheld device of claim 1, wherein the current application mode indicates an inventory management mode of the application is currently active on the handheld device, the first software function controls an inventory function of the handheld device, the first action operates a barcode scanner associated with the inventory function, and the third action operates a camera associated with the inventory function.

9. The handheld device of claim 1, wherein to calculate the orientation, the controller is further configured to:
determine a tilt position of the handheld device based on the orientation, wherein the tilt position is based on an angular relationship between the handheld device and a direction of gravity, and the orientation is based on the tilt position.

10. The handheld device of claim 9, wherein the tilt position specifies a left tilt of the handheld device or a right tilt of the handheld device and wherein the device orientation state includes one of a first vertical position with the left tilt, a second vertical position with the right tilt, a first horizontal position, and a second horizontal position.

11. The handheld device of claim 9, wherein the controller is further configured to:
calculate the angular relationship between the handheld device and the direction of gravity by:
calculating a value of α based on a first angle between a first axis parallel to a vertical side of the handheld device and the direction of gravity;
calculating a value of β based on a second angle between a second axis parallel to a horizontal side of the handheld device and the direction of gravity; and
calculating a value of γ based on a third angle between a third axis perpendicular to a display of the handheld device,
wherein the orientation is based on the value of α, the value of β, and the value of γ.

12. The handheld device of claim 1, wherein the orientation condition is defined by a function map for the device orientation state, and wherein the function map specifies a button mapping associated with the current application mode, wherein the button mapping maps the third action to the first physical button and the fourth action to the second physical button.

13. The handheld device of claim 12, further comprising:
a memory configured to store:
a plurality of function maps including the function map for the device orientation state, wherein the plurality of function maps further includes a second function map for a second device orientation state, wherein the second function map specifies a second button mapping associated with the current application mode, wherein the second button mapping maps the first action to the first physical button and the second action to the second physical button.

14. The handheld device of claim 1, wherein the controller is further configured to:
detect a change from the current application mode to the second application mode; and
update, based on the orientation condition and the second application mode, the first software function performed by the first physical button from the second action to the third action.

15. The handheld device of claim 14, wherein the orientation condition defines a function map for the device orientation state, and wherein the function map specifies a third mapping associated with the second application mode, wherein the third mapping maps the first action to the first physical button and the third action to the second physical button and the second mapping maps the section action to the first physical button and the fourth action to the second physical button.

16. The handheld device of claim 1, wherein the orientation condition is a change from a first device orientation state to a second device orientation state.

17. The handheld device of claim 1, wherein the controller is further configured to:
configure, based on the orientation condition and the current application mode, the second application mode of the application.

18. The handheld device of claim 17, wherein the current application mode indicates a phone mode of the application that is currently active on the handheld device, and the second application mode is an inventory management mode of the application.

19. A method for a controller coupled to a handheld device having a first physical button located on a first side of the handheld device and a second physical button located on a second side of the handheld device, wherein the first physical button is configured to perform a first action related to a first software function and the second physical button is configured to perform a second action related to a second software function, the method comprising:
calculating first orientation of the handheld device;
identifying a device orientation state associated with the orientation;
determining an orientation condition based on the device orientation state;
determining a current application mode of an application installed on the handheld device, wherein the application includes the current application mode and a second application mode, and wherein the current application mode is associated with the first orientation of the handheld device and the second application mode is associated with a second orientation of the handheld device;
configuring, based on the orientation condition and the current application mode, the first physical button to perform a third action related to the first software function; and
configuring, based on the orientation condition and the current application mode, the second physical button to perform a fourth action related to the second software function.

20. A non-transitory computer-readable medium storing instructions that, when executed by a controller coupled to a handheld device having a first physical button located on a first side of the handheld device and a second physical button located on a second side of the handheld device, wherein the first physical button is configured to perform a first action related to a first software function and the second physical button is configured to perform a second action related to a second software function, the operations comprising:
calculating an orientation of the handheld device;
identifying a device orientation state associated with the orientation;
determining an orientation condition based on the device orientation state;
determining a current application mode of the handheld device, wherein the application includes the current application mode and a second application mode, and wherein the current application mode is associated with the first orientation of the handheld device and the second application mode is associated with a second orientation of the handheld device;
configuring, based on the orientation condition and the current application mode, the first physical button to perform a third action related to the first software function; and
configuring, based on the orientation condition and the current application mode, the second physical button to perform a fourth action related to the second software function.
